(19) United States
(12) Patent Application Publication
(10) Pub. No.: US 2025/0387767 A1
(43) Pub. Date: Dec. 25, 2025

(54) Blender Appliance with Lid with Pouring Spout

(71) Applicant: Hamilton Beach Brands, Inc., Glen Allen, VA (US)

(72) Inventors: Michael Allen, Glen Allen, VA (US); Drew Carlson, Glen Allen, VA (US)

(73) Assignee: Hamilton Beach Brands, Inc., Glen Allen, VA (US)

(21) Appl. No.: 19/242,131

(22) Filed: Jun. 18, 2025

Related U.S. Application Data
(60) Provisional application No. 63/662,308, filed on Jun. 20, 2024.

(51) Int. Cl. B01F 35/75; A47J 43/07; B01F 35/45; B01F 101/00

(52) U.S. Cl. CPC B01F 35/7548; A47J 43/0716; B01F 35/45; B01F 35/753; B01F 2101/1805

(57) ABSTRACT

A blender includes a lid having a pouring spout. The lid is configured to rest on an upper edge of a jar to cover the interior cavity and includes an outer ring having an outer rim and an inner rim that define a gap. The upper edge of the jar is configured to fit within the gap. An inner disk is positioned radially inwardly of and fixed to the outer ring. The inner disk including a main panel, an aperture, a wall surrounding the aperture, and a spout wall extending upwardly from the wall. An access assembly comprising a bridge mounted to the inner disk, and a spout lid hingedly attached to the bridge, and positioned to interact with the spout wall to cover the spout wall, is included.

### RELATED APPLICATION

The present application claims priority from and the benefit of U.S. Provisional Patent Application No. 63/662,308, filed Jun. 20, 2024, the disclosure of which is hereby incorporated herein by reference in full.

### FIELD OF THE INVENTION

The present invention is directed to small kitchen appliances, and more particularly to blenders.

### BACKGROUND

A blender is a household appliance capable of mixing liquids and chopping dry foods. Blenders are also useful for liquefying fruits and vegetables and for blending solids with liquids. A typical blender includes a blender jar assembly comprising a collar and a container that sits on top of a blender base or housing that encloses a motor. The collar includes a blending tool (often a series of blades) rotatably mounted thereto. The blending tool is rotatably engageable with a drive shaft of the motor in an operating configuration. Foodstuff is placed into the container and the blender jar assembly is engaged with the blender base. The foodstuff is blended within the volume defined by the blender jar, and the blender jar assembly is removed from the blender base to dispense or pour the blended foodstuff.

It may be desirable to provide additional configurations for blenders, and in particular for blender jars.

### SUMMARY

As a first aspect, embodiments of the invention are directed to a blender with a lid having a pouring spout. The blender comprises: a base; a jar that resides above the base, the jar having an interior cavity; and a lid configured to rest on an upper edge of the jar to cover the interior cavity. The lid comprises: an outer ring having an outer rim and an inner rim that define a gap, wherein the upper edge of the jar is configured to fit within the gap, the outer ring formed of an elastomeric material; an inner disk positioned radially inwardly of and fixed to the outer ring, the inner disk including a main panel, an aperture, a wall surrounding the aperture, and a spout wall extending upwardly from the wall; and an access assembly comprising a bridge mounted to the inner disk and a spout lid hingedly attached to the bridge and positioned to interact with the spout wall to cover the spout wall.

As a second aspect, embodiments of the invention are directed to a lid for a blender comprising: an outer ring having an outer rim and an inner rim that define a gap, wherein an upper edge of a blender jar is configured to fit within the gap, the outer ring formed of an elastomeric material; an inner disk positioned radially inwardly of and fixed to the outer ring, the inner disk including a main panel, an aperture, a wall surrounding the aperture, and a spout wall extending upwardly from the wall; and an access assembly comprising a bridge mounted to the inner disk and a spout lid hingedly attached to the bridge and positioned to interact with the spout wall to cover the spout wall.

As a third aspect, embodiments of the invention are directed to a lid for a blender comprising: an outer ring having an outer rim and an inner rim that define a gap, wherein an upper edge of a blender jar is configured to fit within the gap, the outer ring formed of an elastomeric material; an inner disk positioned radially inwardly of and fixed to the outer ring, the inner disk including a main panel, an aperture, a wall surrounding the aperture, and a spout wall extending upwardly from the wall; and an access assembly. The access assembly comprises: a spout lid hingedly attached relative to the inner disk and positioned to interact with the spout wall to cover the spout wall; and a stirrer stick aperture lid hingedly relative to the inner disk and positioned to interact with the wall to cover the wall.

### BRIEF DESCRIPTION OF THE FIGURES

FIG. 1 is a perspective view of a blender according to embodiments of the invention.

FIG. 2 is a partial perspective view of the blender of FIG. 1 illustrating the flexibility of the outer ring of the lid.

FIG. 3 is a top perspective view of the base of the blender of FIG. 1

FIG. 4 is a top perspective view of the collar of the blender of FIG. 1.

FIG. 5 is a top perspective view of the blender jar of the blender of FIG. 1.

FIGS. 6A and 6B are assembled and exploded top perspective views of the lid for the blender jar of FIG. 5.

FIG. 7 is a top perspective view of the outer ring of the lid of FIG. 6.

FIG. 8 is an enlarged partial section view of the lid of FIG. 6.

FIG. 9 is an enlarged partial section view of the lid of FIG. 6 installed on the upper edge of the jar of FIG. 5.

FIG. 10 is a top perspective view of the inner disk of the lid of FIG. 6.

FIG. 11 is a bottom perspective view of the inner disk of FIG. 10.

FIG. 12 is an exploded perspective view of the access assembly of the lid of FIG. 6.

FIG. 13 is a top perspective view of the bridge of the access assembly of FIG. 12.

FIG. 14 is a bottom perspective view of the bridge of FIG. 13.

FIG. 15 is a top perspective view of the stirring stick aperture lid of the access assembly of FIG. 12.

FIG. 16 is a bottom perspective view of the stirring stick aperture lid of FIG. 15.

FIG. 17 is a top perspective view of the spout lid of the access assembly of FIG. 12.

FIG. 18 is a bottom perspective view of the spout lid of FIG. 17.

FIG. 19 is a side section view of the lid showing the spout lid in the closed position.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

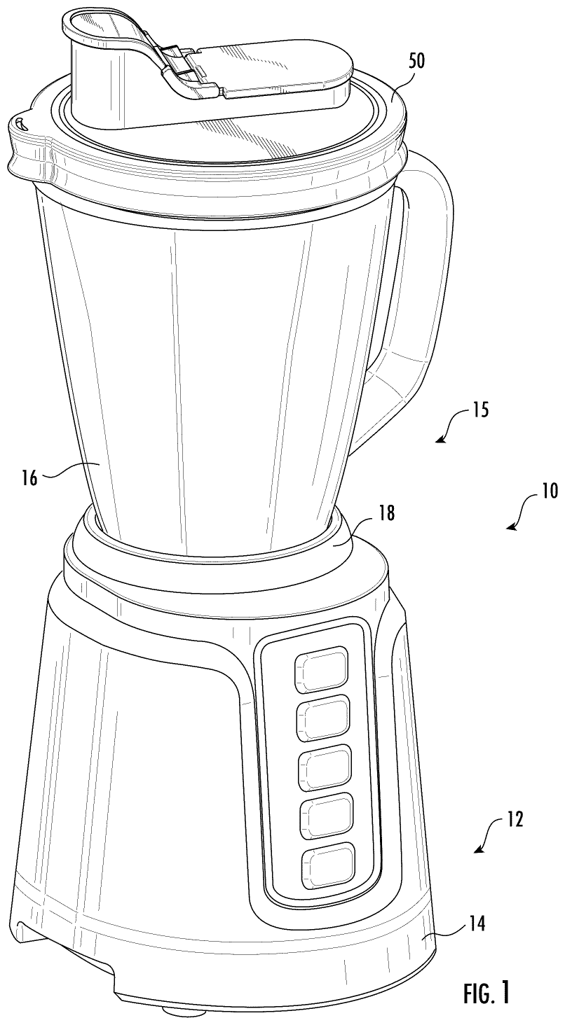

Referring now to the drawings, a blender is shown in FIG. 1 and designated broadly at 10. As can be seen in FIG. 1, the blender 10 includes a base 12 covered with a housing 14 and a blender jar assembly 15 that includes a blender jar 16, a collar 18 that serves as a transition between the base 12 and the blender jar 16, a blending tool unit, which typically includes one or more blades (not shown in the figures), and a lid 50.

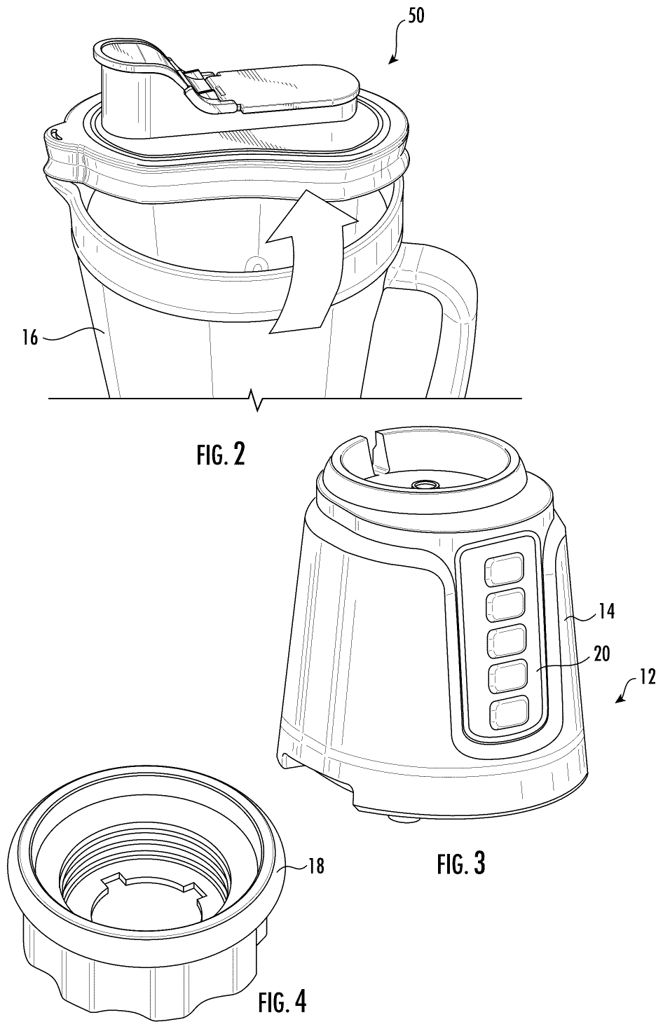

Referring now to FIG. 3, the base 12 is shown therein. As shown therein, the housing 14 is generally cylindrical. A control panel 20 is mounted on the side wall of the housing 14. The control panel 20 is operatively connected with a motor or other drive unit mounted within the housing. The motor is attached with a fitting that is configured to serve as an interface with the blending tool unit of the blender jar assembly 15 to enable it to rotate. Those of skill in this art will appreciate that the base 12 may be of conventional construction and need not be described in detail herein. An exemplary base is discussed in U.S. Pat. Nos. 7,422,236 and 7,950,842, the disclosure of each of which is hereby incorporated herein by reference in full. The collar 18 is shown in FIG. 4.

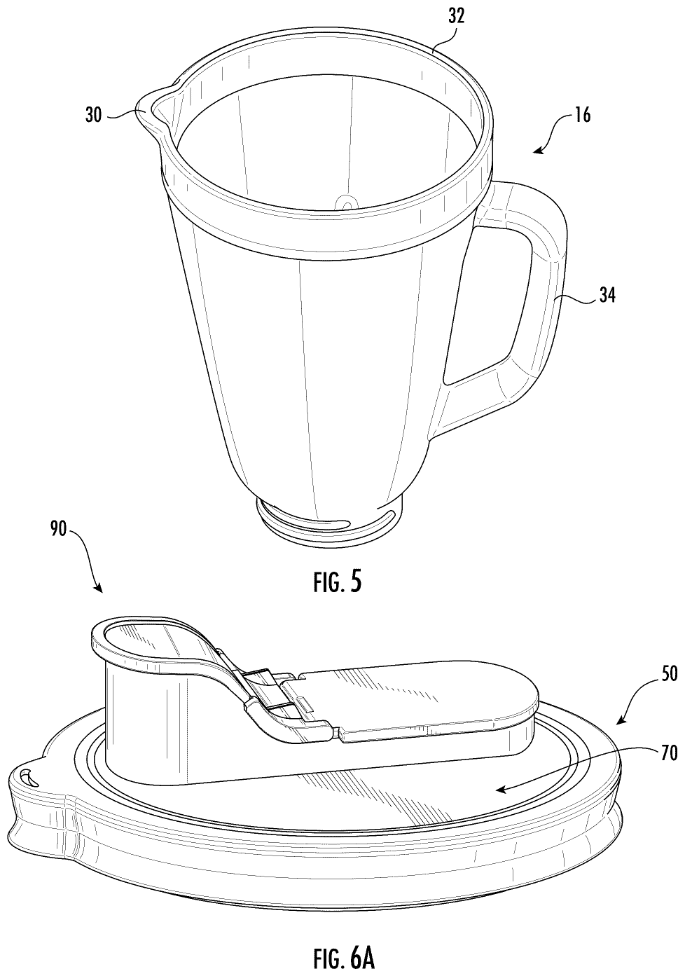

Referring now to FIG. 5, the blender jar 16 is of conventional structure (it is an open-ended container with an interior cavity) and is typically formed of glass or another glass-like material. The blender jar 16 includes a spout 30 on one side of the upper edge 32 and a handle 34 mounted to the side wall of the blender jar diametrically opposite the spout 30.

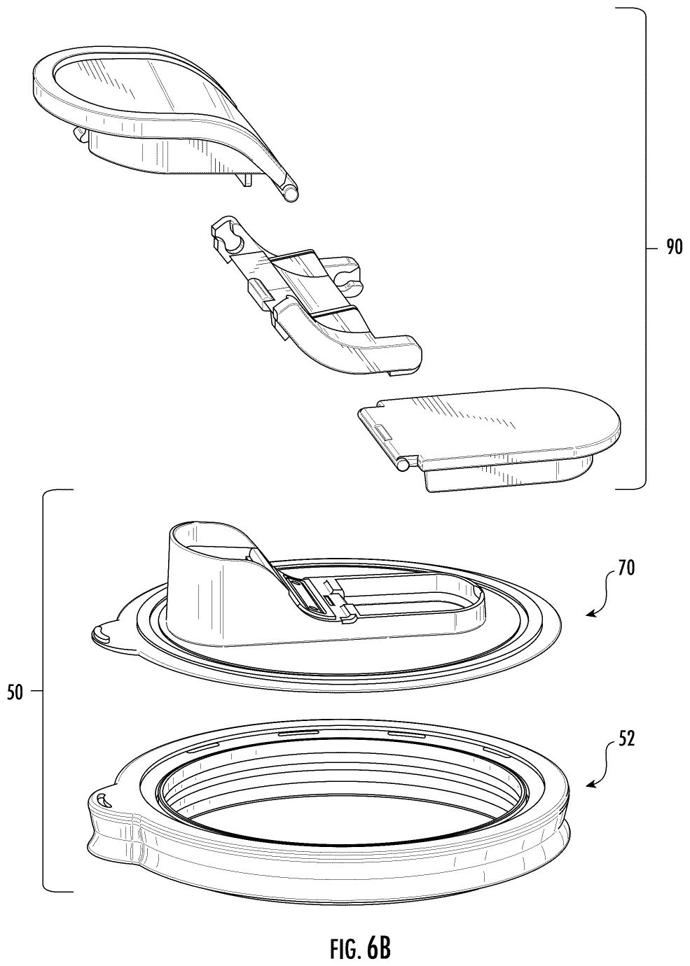

Referring now to FIGS. 6A and 6B, the lid 50 for the blender jar 16 is shown therein. In a conventional blender jar assembly 15, the lid is formed of a relatively rigid plastic, and has a depending lip that fits inside the upper edge of the blender jar. However, in some instances, the lid can become stuck or wedged inside the jar, and therefore can be difficult to remove, particularly for users that may have lost strength in their hands (e.g., some elderly or infirm users).

To address this, the lid 50 of the blender jar assembly 15 is configured to provide sufficient cover for operation of the blender 10, but also may be easier to remove from the blender jar 16. The lid 50 (shown assembled in FIG. 6A and exploded in FIG. 6B), has an elastomeric (e.g., rubber) outer ring 52, an inner disk 70 that fits within the outer ring 52, and a three-piece access assembly 90. These components are discussed separately below.

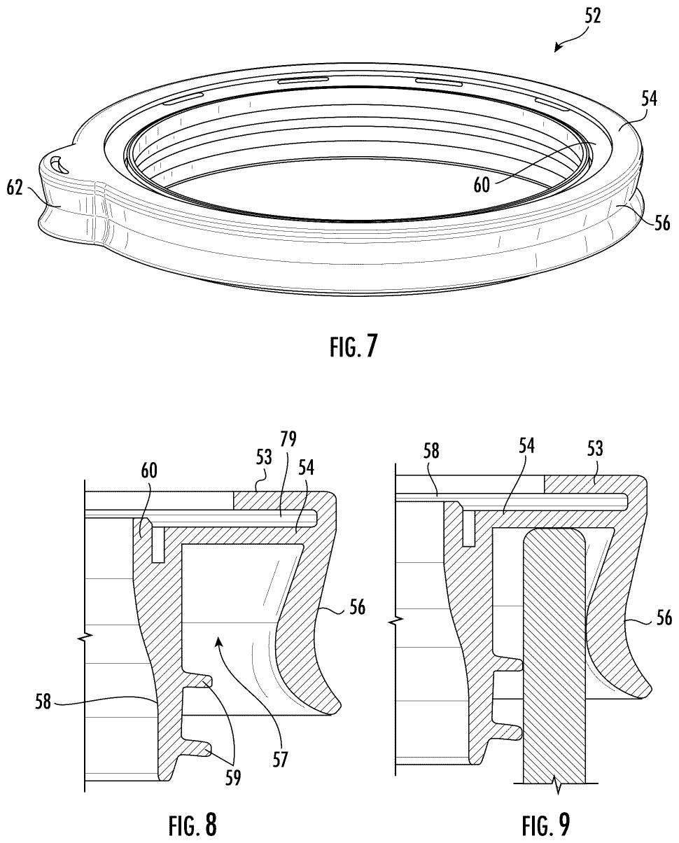

Referring now to FIGS. 7-9, the outer ring 52 is generally annular and has a main body 54, an upper rim 53 above the main body 54, an outer lip 56 that extends downwardly from the outer edge of the main body 54, an inner lip 58 that extends downwardly from the main body 54 radially inwardly of the outer lip 56, and an inner flange 60 that extends upwardly radially inwardly from the inner edge of the inner lip 58. Ridges 59 extending radially outwardly from the outer surface of the inner lip 58. A gap 57 is defined between the inner lip 58 and the outer lip 56 and receives the upper end of the blender jar 16 (FIG. 9). Also, as seen in FIG. 8, the outer lip 56 extends downwardly considerably less than the inner lip 58. The outer ring 52 also has a protrusion 62 that is sized and configured to fit over the jar spout 30 of the blender jar 16. The interaction between the jar spout 30 and the outer ring 52 helps to orient the outer ring 52 (and as a result the entire lid 50) correctly relative to the blender jar 16.

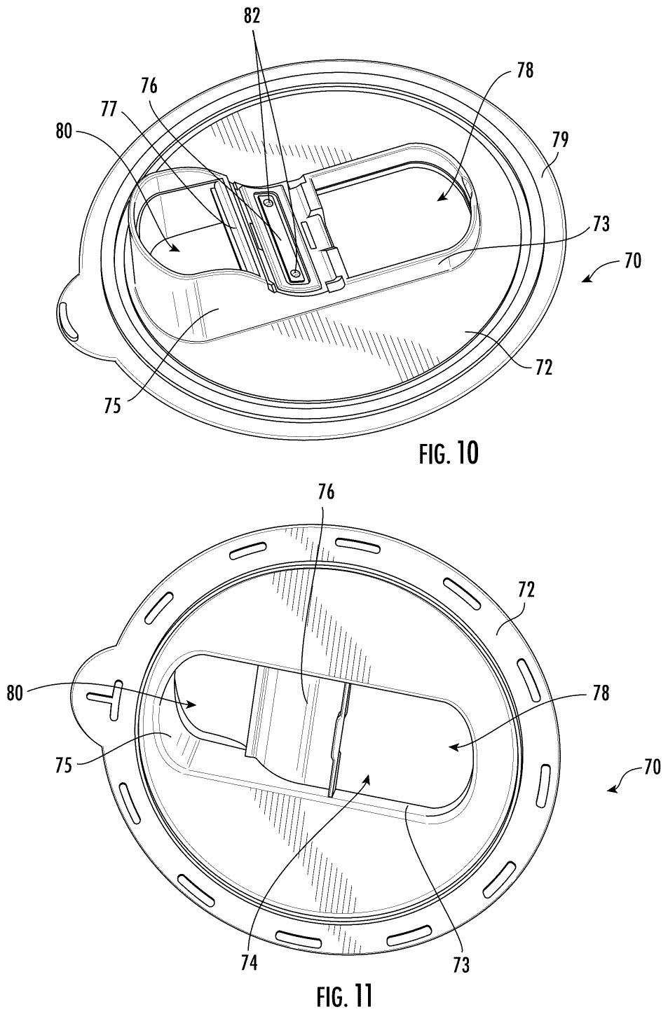

Referring now to FIGS. 10 and 11, the inner disk 70 includes a flat main panel 72 with an oblong aperture 74 in the center. A rim 79 encircles the main panel 72. A wall 73 surrounds the aperture 74 and extends upwardly therefrom. A brace 76 extends across the wall 73. A spout wall 75 extends upwardly from the wall 73 on one side of the brace 76. This, it can be envisioned that the wall 73 and the brace 76 form a stirring stick aperture 78, and the spout wall 75 and the brace 76 form a spout opening 80. Two holes 82 are present in the brace 76.

In some embodiments, the inner disk 70 is formed of a transparent or translucent material, which can enable the user to see the interior of the blender jar 16 from above. The inner disk 70 is typically formed of a relatively rigid polymeric material, such as polypropylene.

The inner disk 70 is attached to the outer ring 52 so that the rim 79 of the main panel 72 of the inner disk 70 overlies the main body 54 of the outer ring 52 and underlies the upper rim 53 (see FIG. 8). These parts may be joined with an adhesive, ultrasonic welding, or by other joining techniques.

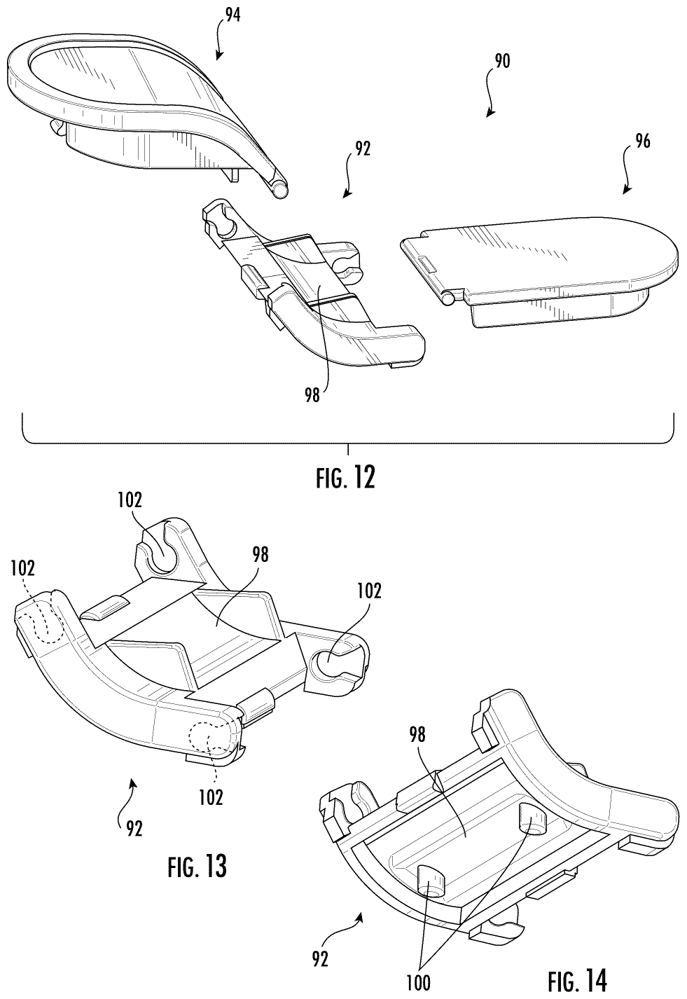

Referring now to FIG. 12, the access assembly 90 includes a bridge 92, a spout lid 94, and a stirring stick aperture lid 96. As seen in FIGS. 13 and 14, the bridge 92 comprises a curved panel 98 with two projections 100 on its lower surface. Hinge posts 102 extend from each corner of the curved panel 98. The bridge 92 is attached to the brace 76 of the inner disk 70 by press-fitting, snap-fitting, etc. the projections 100 into the holes 82 of the brace 76.

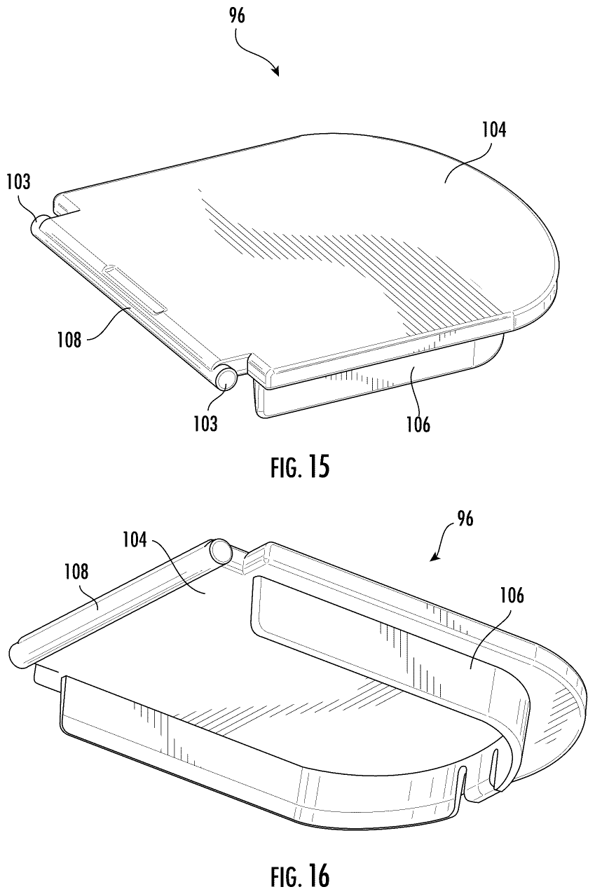

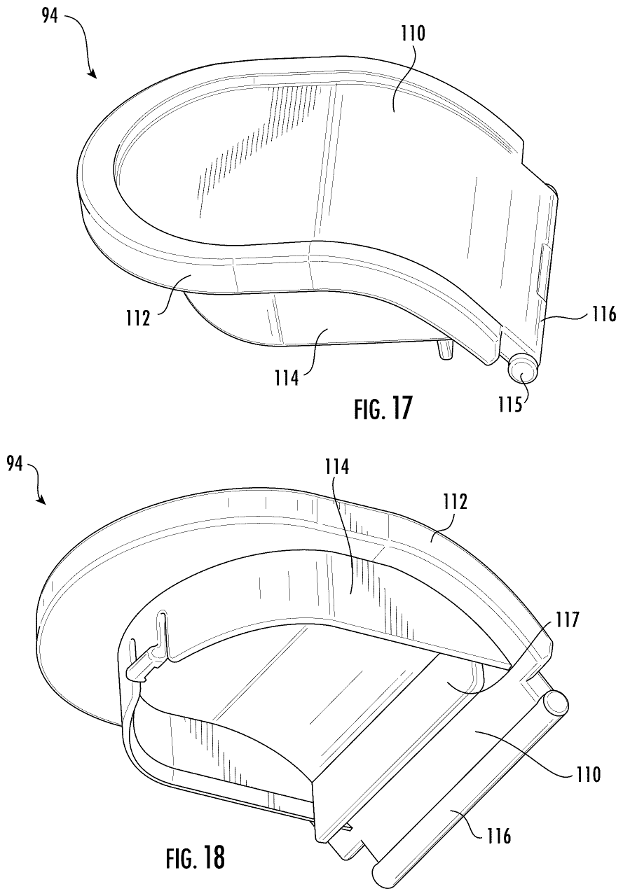

The stirring stick aperture lid 96 (FIGS. 15 and 16) has a flat upper panel 104 and a sealing ridge 106 that extends downwardly from the upper panel 104. A flange 108 extends from the forward edge of the upper panel 104. The stirring stick aperture lid 96 is hingedly attached to the bridge 92 via pins, posts, or the like that extend between the flange 108 and the hinge posts 102 of the bridge 92 (e.g., the pins 103). When the stirring stick aperture lid 96 is in a closed position, the sealing ridge 106 fits within and engages the inner surface of the wall 73 of the inner disk 70 to provide a seal.

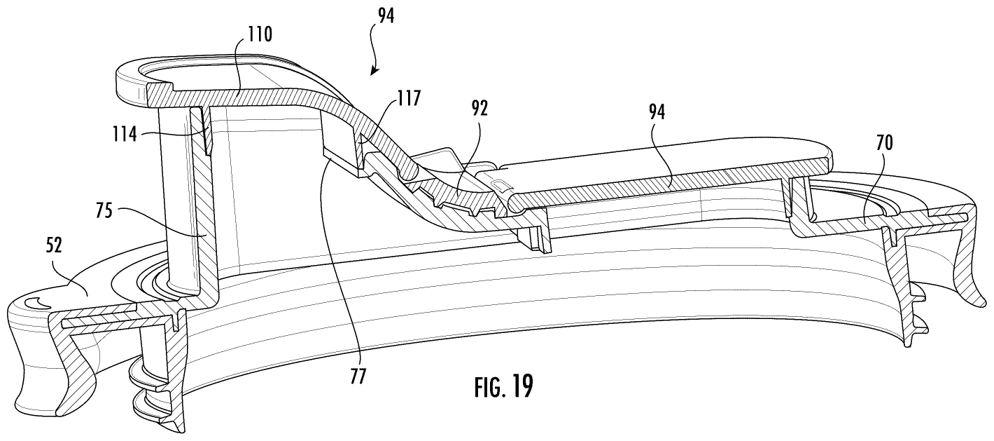

The spout lid 94 (FIGS. 17 and 18) has a curved upper panel 110 that is surrounded on three sides by a rim 112. A sealing ridge 114 extends downwardly from the upper panel 110. A flange 116 extends rearwardly from the upper panel 110. A wall 117 depends from the upper panel 110. Like the stirring stick aperture lid 96, the spout lid 96 is hingedly attached to the bridge 92 via pins, posts, or the like that extend between the flange 116 and the hinge posts 102 of the bridge 92 (e.g., pins 115). When the spout lid 94 is in its closed position, the sealing ridge 114 fits within and engages the spout wall 75 of the inner disk 70 to provide a seal, and the wall 117 fits against a projection 77 on the brace 76 of the inner lid (FIG. 19).

In operation, the blender jar 16 is placed on the base 12, and the lid 50 is positioned on top of the blender jar 16. The upper edges of the blender jar 16 fit within the gap 57 between the inner lip 58 and the outer lip 56 of the outer ring 52. The resilience and flexibility of the material of the outer ring 52 can help to make installation of the lid 50 on the blender jar 16 easier while still maintaining a seal between the lid 50 and the blender jar 16 (see FIG. 2). Both the spout lid 94 and the stirring stick aperture lid 96 are in their closed positions, such that their sealing ridges 114, 106 provide a seal against the spout wall 75 and the wall 73 of the inner disk 70.

During operation, if the user wishes to stir the foodstuff being blended, the user can pivot the stirring stick aperture lid 96 upwardly, which provides access to the interior of the blender jar 16. The use can then stir the foodstuff with a stirring stick (often provided with the blender 10) or the like.

Once the foodstuff is blended, if it is in a sufficiently liquified state, the spout lid 94 can be pivoted upwardly, the blender jar 16 can be removed from the base 12, and the blender jar 16 tipped to pour foodstuff from the blender jar 16 into a receptacle (e.g., a glass). Thus, some or all of the foodstuff can be poured from the blender jar 16 without having to remove the lid 50.

Notably, the spout wall 75 is sufficiently tall that, when the bender jar 16 is tipped for pouring, the poured liquid flowing over the spout wall 75 “clears” the spout 30 and protrusion 62 of the outer ring 52. In some embodiments, the spout wall 75 may be between about 0.25 and 2.0 inches in height.

When the user wishes to have full access to the interior of the blender jar 16, the user can remove the lid 50 by simply lifting with a bit of force to dislodge the inner and outer lips 56, 58 from the upper edge of the blender jar 16 (see FIG. 2). The resilience and flexibility of the outer ring 70 can render this action considerably easier than with conventional blender lids, which as discussed above can tend to get stuck inside the jar.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. A blender, comprising:
a base;
a jar that resides above the base, the jar having an interior cavity; and
a lid configured to rest on an upper edge of the jar to cover the interior cavity, the lid comprising:
an outer ring having an outer rim and an inner rim that define a gap, wherein the upper edge of the jar is configured to fit within the gap, the outer ring formed of an elastomeric material;
an inner disk positioned radially inwardly of and fixed to the outer ring, the inner disk including a main panel, an aperture, a wall surrounding the aperture, and a spout wall extending upwardly from the wall; and
an access assembly comprising a bridge mounted to the inner disk and a spout lid hingedly attached to the bridge and positioned to interact with the spout wall to cover the spout wall.

2. The blender defined in claim 1, wherein the inner disk is formed of polymeric material that is more rigid that the elastomeric material.

3. The blender defined in claim 1, wherein the inner disk is formed of a transparent or translucent material.

4. The blender defined in claim 1, wherein the access assembly is configured so that the spout lid is a distinct and separate component from the bridge.

5. The blender defined in claim 1, wherein the access assembly further comprises a stirrer stick aperture lid hingedly attached to the bridge and positioned to interact with the wall to cover the wall.

6. A lid for a blender, comprising:
an outer ring having an outer rim and an inner rim that define a gap, wherein an upper edge of a blender jar is configured to fit within the gap, the outer ring formed of an elastomeric material;
an inner disk positioned radially inwardly of and fixed to the outer ring, the inner disk including a main panel, an aperture, a wall surrounding the aperture, and a spout wall extending upwardly from the wall; and
an access assembly comprising a bridge mounted to the inner disk and a spout lid hingedly attached to the bridge and positioned to interact with the spout wall to cover the spout wall.

7. The lid defined in claim 6, wherein the inner disk is formed of polymeric material that is more rigid that the elastomeric material.

8. The lid defined in claim 6, wherein the inner disk is formed of a transparent or translucent material.

9. The lid defined in claim 6, wherein the access assembly further comprises a stirrer stick aperture lid hingedly attached to the bridge and positioned to interact with the wall to cover the wall.

10. The lid defined in claim 9, wherein the access assembly is configured so that the spout lid is a distinct and separate component from the bridge, and wherein the stirrer stick aperture lid is a distinct and separate component from the bridge.

11. The lid defined in claim 6, wherein the inner disk includes a brace that divides the aperture, and wherein the bridge is mounted on the brace.

12. A lid for a blender, comprising:
an outer ring having an outer rim and an inner rim that define a gap, wherein an upper edge of a blender jar is configured to fit within the gap, the outer ring formed of an elastomeric material;
an inner disk positioned radially inwardly of and fixed to the outer ring, the inner disk including a main panel, an aperture, a wall surrounding the aperture, and a spout wall extending upwardly from the wall; and
an access assembly comprising:
a spout lid hingedly attached relative to the inner disk and positioned to interact with the spout wall to cover the spout wall; and
a stirrer stick aperture lid hingedly relative to the inner disk and positioned to interact with the wall to cover the wall.

13. The lid defined in claim 12, wherein the access assembly further comprises a bridge that spans the aperture in the inner disk, the spout lid is pivotally attached to the bridge, and the stirrer stick aperture is pivotally attached to the bridge.

14. The lid defined in claim 12, wherein the stirrer stick aperture lid is generally planar.

15. The lid defined in claim 12, wherein the spout lid is configured to pivot about a first axis and the stirrer stick aperture lid is configured to pivot about a second axis that is parallel to but non-collinear with the first axis.

16. The lid defined in claim 12, wherein the inner disk is formed of polymeric material that is more rigid that the elastomeric material.

17. The lid defined in claim 12, wherein the inner disk is formed of a transparent or translucent material.

18. The lid defined in claim 12, in combination with a blender having a jar with an upper edge, wherein the upper edge resides in the gap in the outer ring.
